(19) United States
(12) Patent Application Publication
(10) Pub. No.: US 2015/0144121 A1
(43) Pub. Date: May 28, 2015

(54) CHARCOAL CHIMNEY

(71) Applicant: The Clorox Company, Oakland, CA (US)

(72) Inventors: Donald K. Swatling, Pleasanton, CA (US); Tarric M. EI-Sayed, Pleasanton, CA (US); Amanda Veitch, Pleasanton, CA (US); Scot Herbst, Santa Cruz, CA (US)

(21) Appl. No.: 14/548,983

(22) Filed: Nov. 20, 2014

Related U.S. Application Data
(60) Provisional application No. 61/907,867, filed on Nov. 22, 2013.

(51) Int. Cl. A47J 37/07

(52) U.S. Cl. CPC A47J 37/079
USPC 126/25 B

(57) ABSTRACT

Reusable charcoal chimney devices and inserts which may allow for faster lighting of charcoal material, without any need for lighter fluid. The charcoal chimney device may include a charcoal container including a bottom end, a top end, and a sidewall disposed there between. The charcoal container includes an internal cavity for containing charcoal. The charcoal container may be formed of a non-combustible material so that it can be reused, and is not consumed during use. An elongate insert is disposable within the internal cavity of the charcoal container for forming a hollow flue from a bottom of the internal cavity to the open top end of the charcoal container when charcoal is loaded into the internal cavity around the insert. The hollow flue defining portion of the insert may occupy a minimal fraction of the volume of the internal cavity to limit volume that can no longer be occupied by charcoal.

### CROSS-REFERENCE TO RELATED APPLICATIONS

The application claims the benefit of U.S. Provisional Application No. 61/907,867, filed Nov. 22, 2014, which is hereby incorporated by reference in its entirety.

### THE FIELD OF THE INVENTION

The present invention relates to devices for use with charcoal fuel heating materials. Specifically, the invention relates to charcoal chimney devices for use in starting combustion of charcoal for subsequent use of the charcoal in cooking (e.g., grilling).

### RELEVANT ART

Charcoal heating materials, such as charcoal briquettes, are commonly used for cooking food. Foods cooked with charcoal can have a unique flavor and have wide appeal. Conventional charcoal briquettes generally provide a relatively slow-burning fuel with a high BTU output.

One of the shortcomings of conventional charcoal briquettes is that the briquettes can be difficult to ignite and may not continue to burn, even after they appear to have been ignited. To address this problem, lighter fluid may be sprayed onto the briquettes by the user immediately prior to use, or may be applied during manufacture to provide “easy-to-light” briquettes. Still, some feel that use of such flammable petroleum-based materials may impart unwanted flavors to the food. Additionally, the use of lighter fluid emits volatile organic compounds (VOCs), which could potentially have an effect on air quality.

In addition to the difficulty in lighting conventional charcoal briquettes, once ignited, conventional charcoal briquettes typically must complete an initial “ignition phase,” or formation of visible ash on a majority of the briquette before they are suitable for cooking. Once past the ignition phase, the briquettes burn with an intense heat throughout a “burn phase” during which a consumer can use the briquettes for cooking. Unfortunately, the ignition phase of conventional briquettes often requires considerable time. Charcoal chimneys are used to ignite charcoal without the need for lighter fluid, although it takes a significant amount of time for the charcoal within the chimney to reach a point where the charcoal is ready for use in cooking food (e.g., typically 20 minutes or more).

### BRIEF DESCRIPTION OF THE DRAWINGS

The invention will be described and explained with additional specificity and detail through the use of the accompanying drawings in which:

FIG. 1A is a perspective view of an exemplary charcoal chimney device having a standard handle design according to the present invention;

FIG. 1B is a perspective view of an exemplary insert that may be inserted within the internal cavity of the charcoal chimney device of FIG. 1A;

FIG. 1C is a partial cut-away view of the charcoal chimney of FIG. 1A, showing the insert of FIG. 1B received therein;

FIG. 2A is a perspective view of an alternative exemplary insert;

FIG. 2B is a perspective view of the insert of FIG. 2A showing an associated funnel for use in loading charcoal into the charcoal chimney around the insert;

FIG. 2C is a perspective view of another alternative exemplary insert configured as a wire mesh cylinder that can be seated on a grating at the bottom of the internal cavity of the charcoal chimney;

FIG. 3A is a cross-sectional view of a charcoal chimney device similar to that of FIG. 1A loaded with charcoal;

FIG. 3B is a cross-sectional view of a charcoal chimney device similar to that of FIG. 3A, where an insert such as that of FIG. 2A has been used to load the internal cavity, after which the insert has been removed;

FIG. 4A is a perspective view of an exemplary charcoal chimney device having an alternative handle design according to the present invention;

FIG. 4B is a partial cut-away view of the charcoal chimney of FIG. 4A, showing the insert of FIG. 1B received therein;

FIG. 5A is a cross-sectional view of a charcoal chimney device similar to that of FIG. 4A loaded with charcoal;

FIG. 5B is a cross-sectional view of a charcoal chimney device similar to that of FIG. 5A, where an insert such as that of FIG. 2A has been used to load the internal cavity, after which the insert has been removed.

### DETAILED DESCRIPTION OF THE PREFERRED EMBODIMENTS

### I. Introduction

The present invention is directed to reusable charcoal chimney devices, and inserts for use therewith, which allows for faster lighting of the charcoal material within the charcoal chimney, without any need for lighter fluid. In an embodiment, the charcoal chimney device includes a charcoal container including a bottom end, an open top end, and a sidewall disposed there between. The charcoal container includes an internal upper cavity for containing charcoal and an internal lower cavity for the initiator fuel such as newspaper or other easy to light fuel source. The charcoal container may be formed of a non-combustible material so that it can be reused, and is not consumed during use.

An elongate insert may be provided that is disposable within the internal cavity of the charcoal container for forming a hollow flue core from the bottom of the internal, upper cavity to a bottom of the internal cavity to the open top end of the charcoal container when charcoal is loaded into the internal cavity around the insert. The insert may be configured so as to provide the described hollow flue while occupying a minimal fraction of the volume of the internal cavity. Providing an insert that allows formation of a vertical hollow flue within the packed charcoal has been found by the present inventors to result in significantly faster lighting of the charcoal. In addition, by limiting the volume occupied by the resulting hollow flue, the volume of charcoal that can be held by the charcoal chimney with the insert therein is only minimally affected.

For example, in contrast, U.S. Pat. No. 5,197,455 to Tessien describes a charcoal chimney that may include a grate having a conical shape that fits within the charcoal chimney, which conically shaped grate may resemble a witch's hat, including a wide base that tapers towards the top. The grate stops far short of the top of the charcoal chimney when inserted therein. The conical grate occupies a large fraction of the internal space that otherwise could be filled with charcoal, resulting in a loss in volume of likely 25% or more. As a result, even if the Tessien system were to result in faster lighting, it results in a large reduction in the volume of charcoal that can be prepared (e.g., likely a loss of 25% or more) with a given charcoal chimney. Another disadvantage associated with use of a conical grating as in Tessien is it leads to increased variability in the timing at which the charcoal in different portions of the charcoal chimney are lit. For example, the briquettes in the base of the chimney burn up much more quickly than those at the top, because of the enormous difference in air flow between these regions.

The inserts of the present invention on the other hand may be configured to preserve a much higher fraction of the internal cavity volume to be filled with charcoal. For example, the insert may include a hollow flue portion that defines the hollow flue that occupies no more than about 5%, no more than about 3%, or no more than about 2% of the volume of the internal cavity in which charcoal is to be loaded. To achieve this, rather than exhibiting a wide base conical shape, which occupies much of the internal cavity, the portion of the insert defining the hollow flue may exhibit little or no taper, while also extending the entire length or near the entire length of the cavity. This may provide a flue with a substantially uniform transverse cross-section or cross-sectional area from the bottom of the internal cavity to the open top end of the charcoal container. In an embodiment, the portion of the insert defining the hollow flue, and the hollow flue resulting therefrom may be substantially cylindrical, around which the charcoal may be loaded. If any taper is provided to the flue portion of the insert, the taper may be relatively moderate, so as to minimize charcoal volume lost to the hollow flue. Of course, other cross-sectional shapes are also possible (e.g., square, rectangular, oval, etc. In addition, it may be possible to provide more than one hollow flue (e.g., 2 or 3 vertical hollow flues, spaced apart from one another). That said, a single central hollow flue may best minimize charcoal volume lost to the formation of the flue(s).

The inventive insets (in contrast to a conical insert with a wide base, and narrow top, as in Tessien) provide more consistent lighting of a smaller portion of the entire chimney around the core (as compared to, for example, Tessien), but sufficient enough to also light the whole pile after it is poured out. This method of lighting the chimney allows for more fuel to be burned as part of the cooking time instead of the time in the chimney.

### II. Exemplary Charcoal Chimney Devices and Associated Inserts

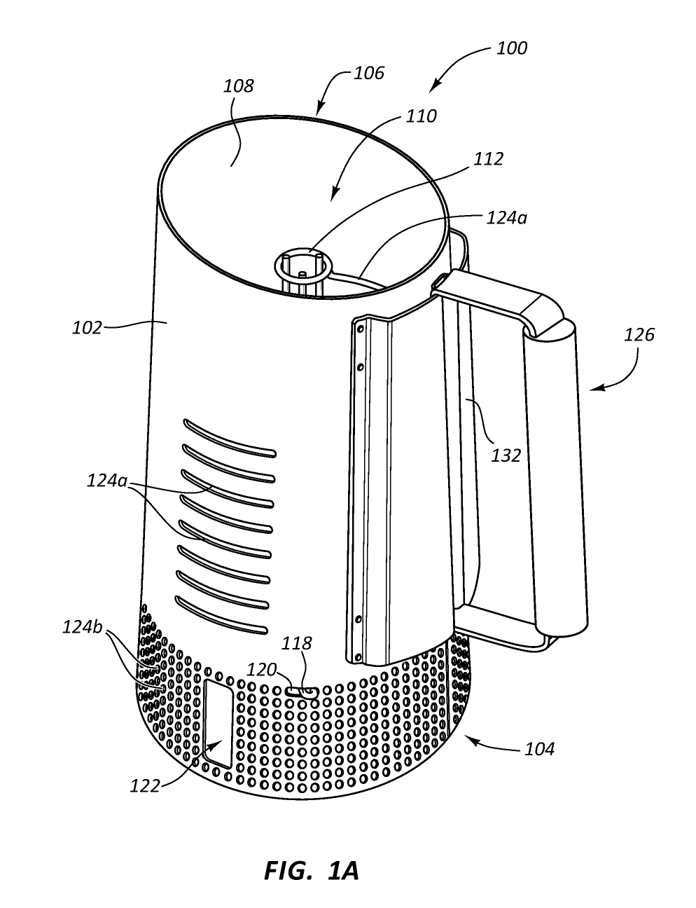

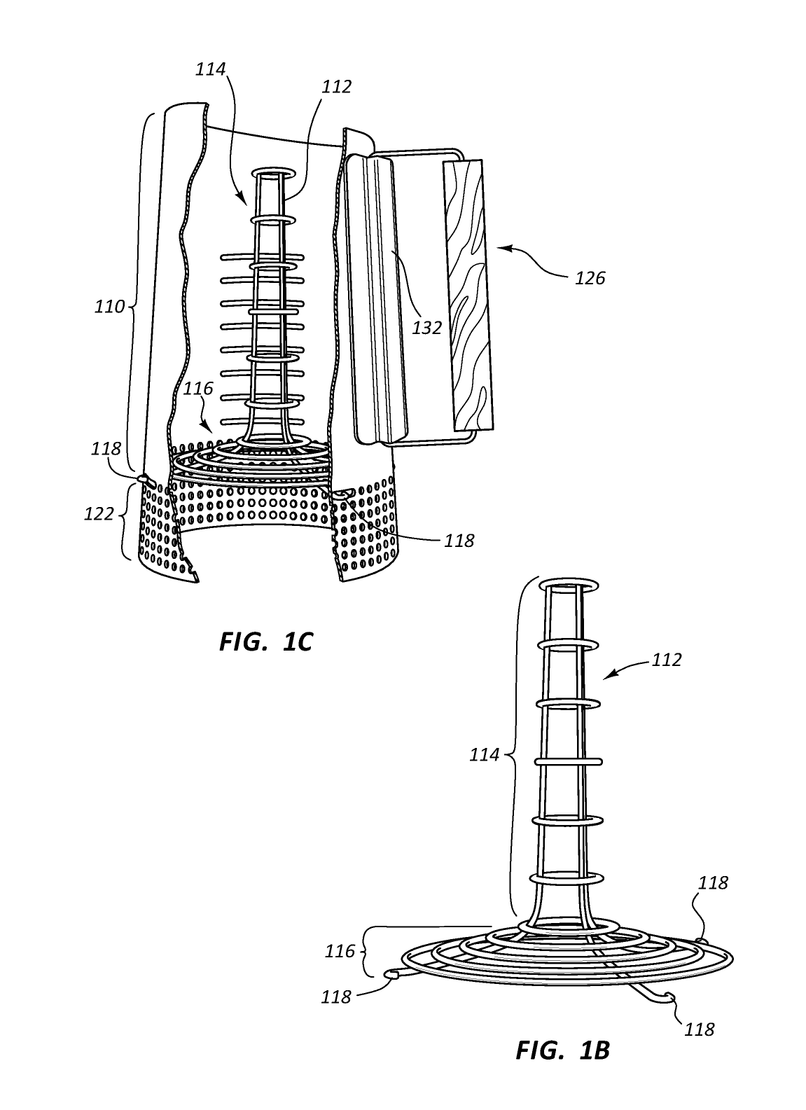

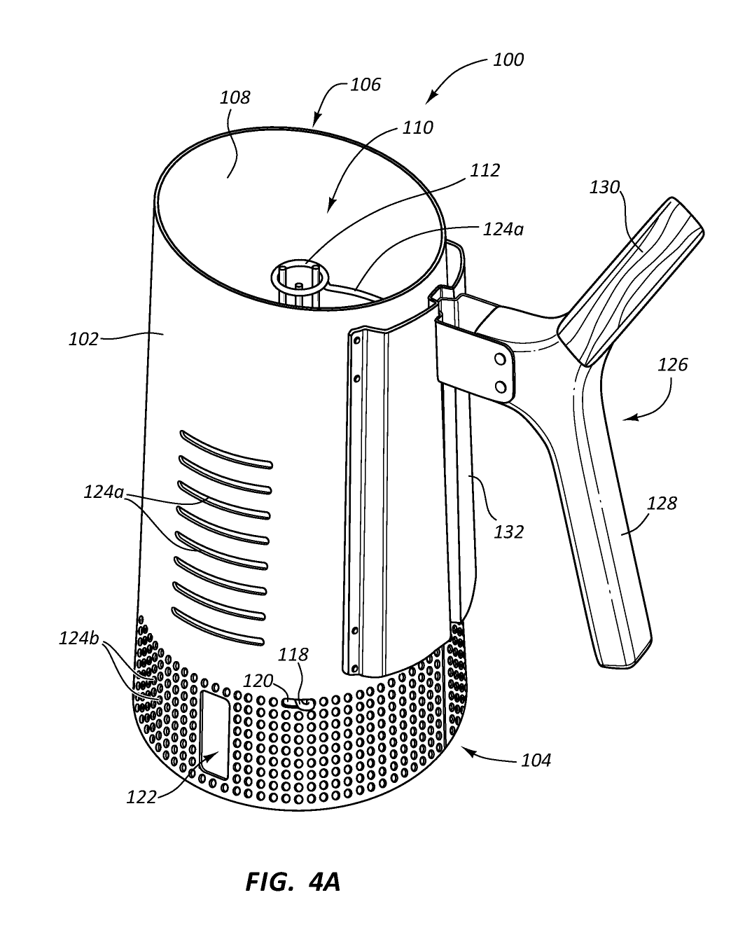

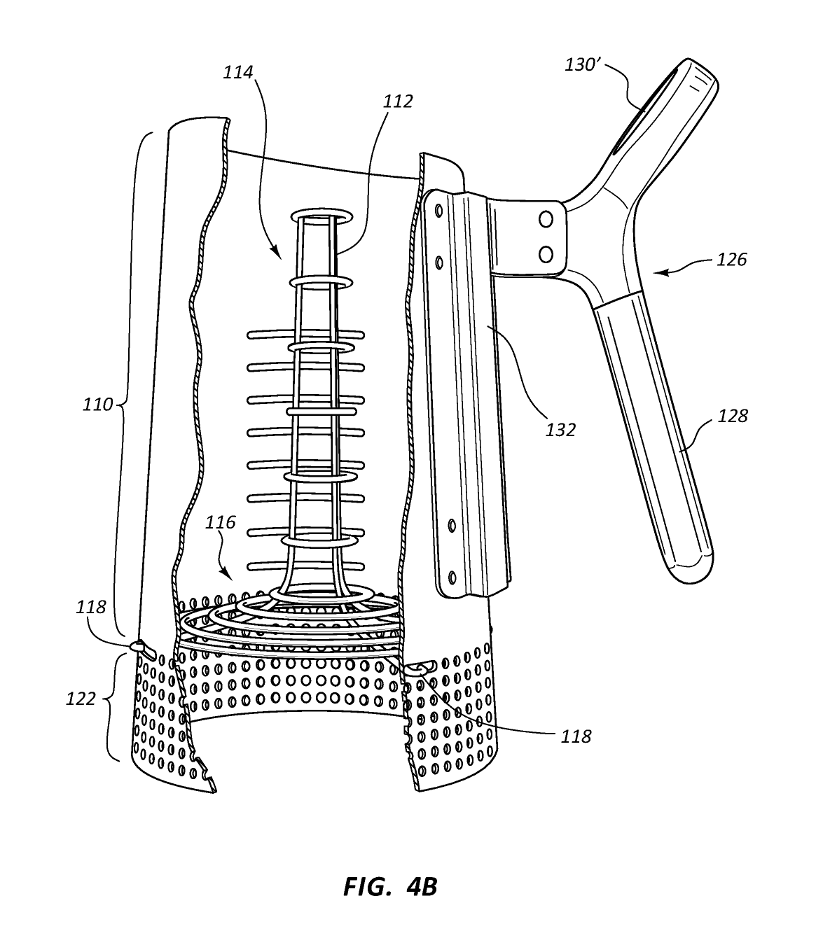

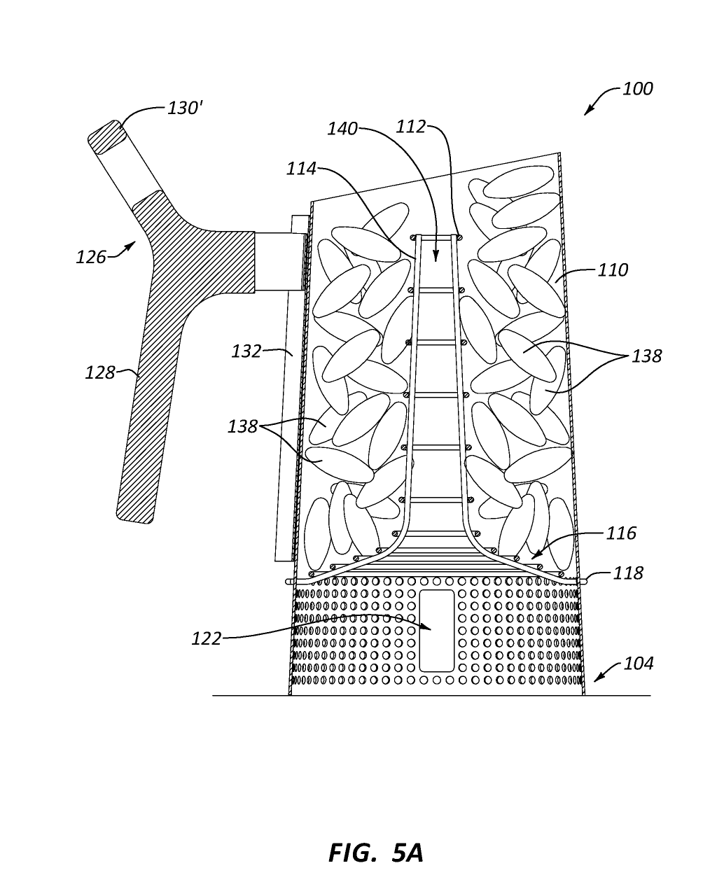

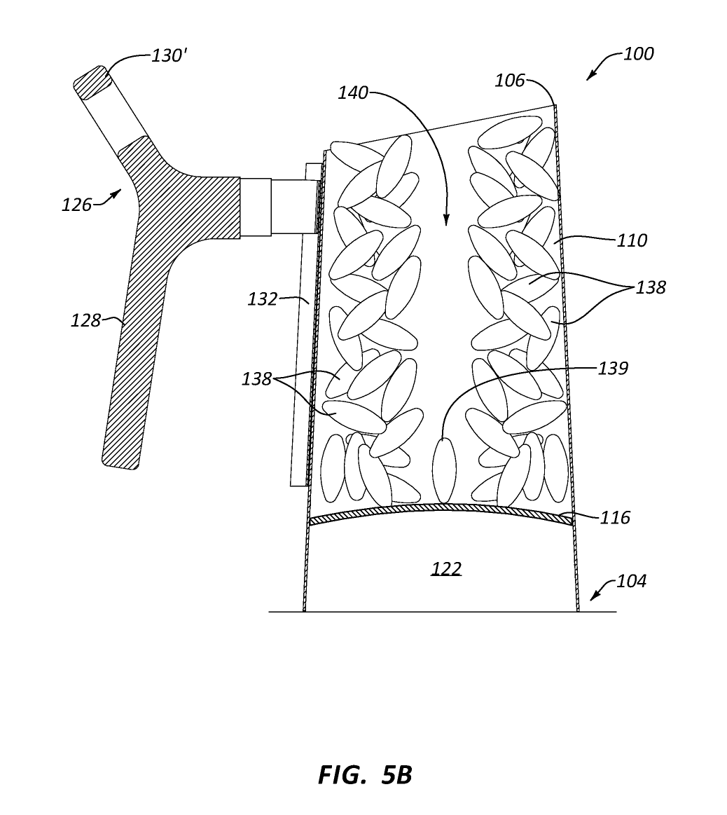

FIGS. 1A-1C and 4A-4B each illustrate an exemplary charcoal chimney device 100 according to an embodiment of the present invention. FIGS. 4A and 4B depict a chimney with a unique pouring handle, but otherwise behave comparable to chimneys depicted in FIGS. 1A-1C and may use the same insert depicted in FIG. 1B. Device 100 includes a charcoal container 102 including a bottom end 104, a top end (e.g., open) 106, and a sidewall 108 disposed there between. While the illustrated container 102 is generally cylindrical, it will be appreciated that other shapes may be provided (e.g., a square or rectangular transverse cross-section for a container that may be collapsible, etc.). Charcoal container 102 includes an internal cavity 110 for containing charcoal. Charcoal container 102 may be formed of a non-combustible material (e.g., sheet metal) so as to be reusable, rather than consumed during lighting of charcoal contained therein.

An insert 112 may be disposable within internal cavity 110 of container 102. Insert 112 is shown separate from container 102 in FIG. 1B. Insert 112 may include an elongate, longitudinally oriented flue portion 114, as well as a base portion 116 at a bottom of the flue portion. In the illustrated embodiment, base portion 116 may serve as a grate upon which charcoal loaded into cavity 110, while also defining the bottom of cavity 110. In addition, base portion 116 may engage with sidewall 108 (e.g., as legs 118 are received into corresponding slots 120—see FIGS. 1A, 1C, 4A and 4B) to support insert 112 within container 102. In the illustrated embodiment, flue portion 114 and base portion 116 may be integral, fixedly attached to one another. In another embodiment, such portions may be separable from one another (e.g., a base grating may be provided separate from an insert defining the hollow flue).

Base portion 116 defines the upper and lower cavities, with the upper cavity 110 loaded with charcoal and the lower cavity 122 filled with newspaper or the like. The base portion 116 may be flat or conical in shape. The preferred embodiment is with a conical shape where the height to diameter ratio is at least 0.2 and the most preferred ratio is at least 0.3. Flue portion 114, which does reduce the volume of internal cavity 110 to some degree, may be configured to minimize such volume reduction. For example, in the illustrated configuration, flue portion 114 is elongate and relatively slender, and exhibits a substantially constant transverse cross-sectional thickness from its bottom (at the interface of base portion 116 and flue portion 114) to its top end. In an embodiment, the volume defined by flue portion 114 may be substantially cylindrical, exhibiting relatively little or no taper. If a slight taper is included, the bottom of flue portion 114 may be slightly larger in diameter and transverse cross-sectional area than the top of flue portion 114 (or vice versa). Where a taper is provided, the bottom dimension (e.g., diameter) may be not more than twice that of the top, not more than about 65% larger than the top, or not more than 50% more than the top.

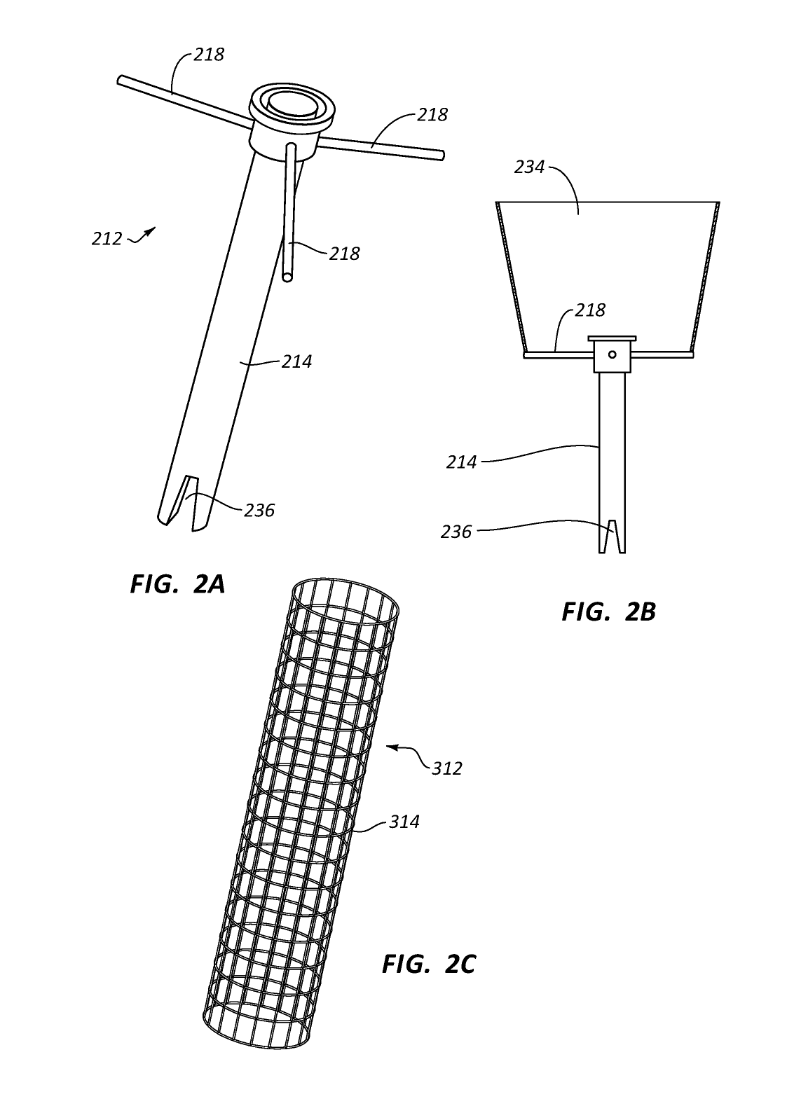

By way of example, flue portion 114 may have an average thickness (e.g., diameter) that is not more than about 25%, or not more than about 20% that of the container 102. For example, where container 102 may have a diameter of about 6.75 inches, flue portion 114 may have a diameter that is about 0.5 to about 1.5 inches, (e.g., 1.25 or 1.125 inches). Smaller or larger diameters may also be possible, for both container 102 and/or flue portion 114 (e.g., flue portion from about 0.5 inch to about 2.5 inches, 0.5 to about 1.25 inch, 1.25 to about 2.5 inch, etc.). Where container 102 has a larger diameter (e.g., up to about 12 inches), it may be desirable to provide flue portion 114 of insert 112 with a larger diameter as well (e.g., about 1.25 to about 2.5 inches), or with multiple smaller flue portions. Particularly where the flue portion has a diameter greater than the dimensions of the charcoal to be employed therewith, it may be advantageous for the top of the insert to be to be partially closed to prevent charcoal from falling into the hollow flue while allowing air to flow up through the flue. For example, for a wire body insert such as that seen in FIG. 2C, the wires may come together at the top to prevent charcoal entry into the hollow flue.

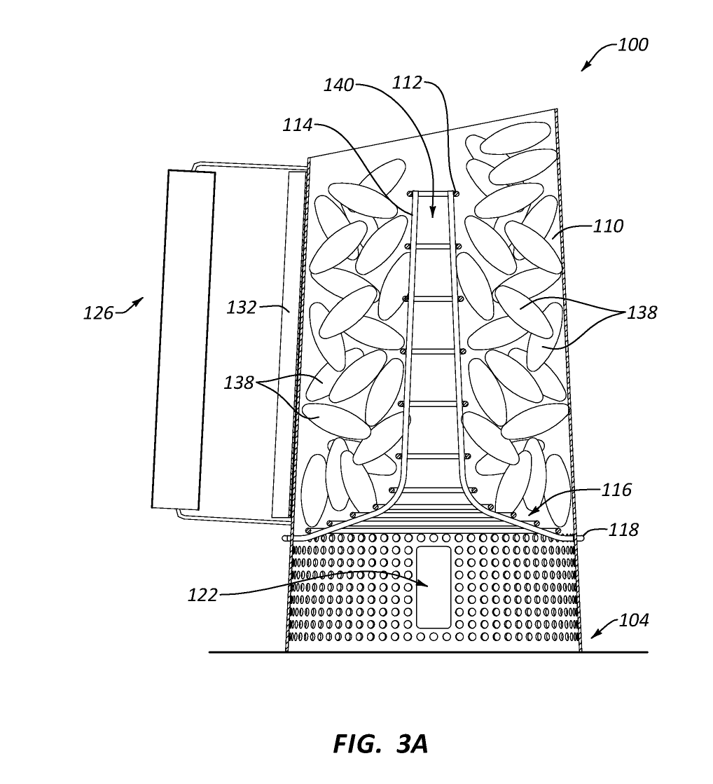

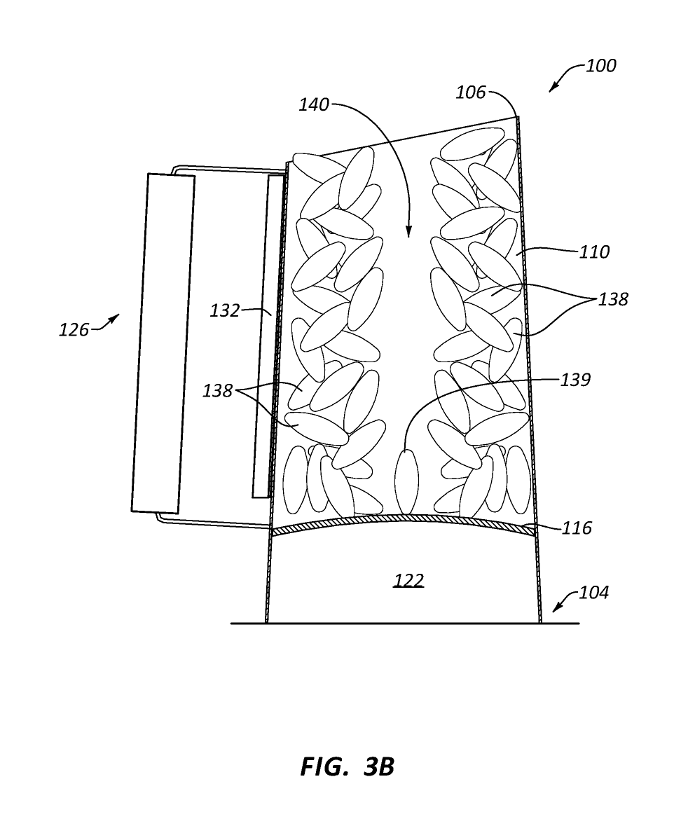

Flue portion 114 may have a height such that it may extend at least the full height of internal cavity 110, or substantially the full height thereof. If flue portion 114 stops short of open top end 106 of container 102, it may extend, e.g., at least about 75% of the height of cavity 110, at least about 80% of the height of cavity 110, at least about 90% of the height of cavity 110, at least about 95% of the height of cavity 110, to within about 2.5 inches of open top end 106, to within about 2 inches of open top end 106, or to within about 1 inch of open top end 106. Where flue portion stops short of open top end 106, the charcoal may be loaded within cavity 110 to ensure that the resulting hollow flue defined by flue portion 114 is not covered over with charcoal upon loading, but that a hollow portion above the top of flue portion 114 continues to the open top end (FIG. 3A).

Providing a flue portion 114 that stops before reaching open top end 106 may be advantageous as it prevents the top of flue portion 114 from interfering with charcoal as it is poured out of charcoal chimney 100 once it has been lit, and is ready for use in cooking. As described above, where this is the case, care may be taken to load charcoal within the very top portion (e.g., the final 1-2 inches or so) of cavity 110 so as to maintain the presence of the hollow flue, so that the flue is open to top end 106, as seen in FIG. 3A.

In addition, because the flue portion of insert 112 minimizes lost charcoal volume as described above, this minimal amount of lost charcoal volume can be recouped by simply heaping the charcoal over open top end 106 when filling cavity 110, rather than simply filling cavity 110 level to top end 106, as is conventionally done. Where the volume lost due to formation of the hollow flue is less than 10%, or less than 5% of the cavity 110 volume, it is possible to recoup all or nearly all of the lost volume by such heaping. For example, if the flue portion 114 occupies the space of 5 or 6 charcoal briquettes that could otherwise have been added to cavity 110, these 5 or 6 briquettes may simply be heaped onto the top, above top end 106. This is possible because the amount of lost volume is relatively small, e.g., less than about 10%, or less than about 5% (e.g., 3-4%), rather than substantially higher amounts such as 25% or more, where heaping would not be capable of recouping the loss.

As perhaps best seen in FIG. 1C, charcoal chimney 100 may include a second cavity 122 below internal cavity 110. For example, internal cavity 110 may be separated from second, lower cavity 122 by base portion 116 of insert 112, or a similar grating separating the two cavities (e.g., such a base portion grating may be separate from an insert that may include the flue portion, without an enlarged base grate portion). Second cavity may allow a user to insert starting fuel (e.g., newspaper or similar) into lower cavity 122 for use in igniting charcoal loaded within upper cavity 110.

Vents 124a, 124b may be provided within either or both of cavities 110, 122 for increasing air flow.

Charcoal chimney 100 may include a handle to facilitate gripping of chimney 100 by a user. Chimney 100 shown in FIGS. 1A-1C illustrates a handle 126 that facilitates dumping of the ignited charcoal out of chimney 100 after use, when the lit charcoal is ready for use in cooking. In another embodiment, Charcoal chimney 100 may include a handle to facilitate gripping of chimney 100 by a user. Chimney 100 shown in FIGS. 4A and 4B illustrates a dual grip handle 126 that facilitates steady, safe dumping of the ignited charcoal out of chimney 100 after use, when the lit charcoal is ready for use in cooking. Dual grip handle 126 includes two gripping portions, to provide for two handed gripping for increased steadiness and safety as the hot charcoal is dumped out. For example, dual grip handle 126 may be attached to an exterior of sidewall 108 of container 102. Dual grip handle 126 may include an elongate first lower handle 128 that is grippable by one hand of a user, while a second T-bar or loop shaped handle 130, 130′ is provided above lower first handle 128. FIG. 4A shows a T-bar shaped handle 130, while FIG. 4B shows an alternative loop shaped handle 130′. In either case, second handles 130, 130′ each provide a gripping member that is oriented transverse to the lower first handle 128. This allows a user to grip first lower handle 128 with one hand, while gripping the upper transverse (e.g., the handles may extend longitudinally generally perpendicular to one another) handle 130 or 130′ with their other hand, providing a very steady grip on container 102, as hot charcoal is poured therefrom.

A heat shield 132 may be disposed between the handle 126 and the exterior sidewall of charcoal container 102. Heat shield may help to limit heat radiated towards handle 126, which may otherwise make gripping of handle 126 difficult or uncomfortable due to the proximity of hot charcoal within container 102.

FIGS. 2A-2C illustrate alternative insert configurations that may be employed in forming a hollow flue within a volume of charcoal as the charcoal is loaded into internal cavity 110 of a charcoal chimney device. For example, FIG. 2A shows an insert 212 which may include an elongate flue portion 214. Insert 214 may include a plurality of laterally extending legs 218 disposed adjacent a top portion of flue portion 214. Legs 218 extend from insert 212, so as to be engageable with sidewall 108 of the charcoal container 102. As insert 212 does not include an enlarged grating base at its distal end, laterally extending legs 218 serve to stabilize insert 212 once it is inserted into internal cavity 110 of a charcoal container 102. A separate grating base separating the chimney's upper and lower cavities may be provided within the charcoal chimney against which the bottom of flue portion 214 may engage.

FIG. 2B shows insert 212 including a funnel portion 234 attached to the top end of insert 212, which funnel may aid in loading charcoal into internal cavity 110 of a charcoal container 102 when insert 212 is disposed therein. Funnel portion 234 could be removable so as to allow it to be attached to top end of insert 212 when it is desired to load with charcoal, but could otherwise be removable (e.g., when inserting flue portion 214).

Flue portion 214 could further include a plurality of vertically oriented longitudinal wires (e.g., 3-4 wires, 5-6, wires, 7, wires, etc.) running along the length of flue portion 214, to hold charcoal away from the solid or hollow flue portion 214. Such a configuration may reduce sliding friction between insert 212 and the charcoal as the insert 212 is removed after loading of the charcoal and before its ignition.

Insert 212 of FIG. 2A also includes a slot 236 at a distal end of flue portion 214. Inventors have found that lighting of the charcoal can be achieved even faster if a charcoal briquette is positioned at the bottom of the otherwise open hollow flue. A single charcoal briquette may be placed vertically on end at the bottom of the hollow flue (e.g., against a grating separating the upper and lower cavities of the charcoal chimney). Air flow is possible around this briquette, which becomes very hot, leading to even faster igniting of the other briquettes. Slot 236 facilitates placement of a briquette (e.g., a single briquette) in a vertical orientation at the bottom of the hollow flue. Such a briquette may be placed from above (e.g., using slot 236) or from below (e.g., through the separating grating)

Flue portion 214 of insert 212 may be solid (e.g., a wood dowel or other material). It could alternatively be hollow, or a wire frame. It is not necessary that the inserts of the present invention (e.g., insert 212) remain within the internal cavity 110 of the charcoal chimney during use. For example, the insert 212 may be positioned within cavity 110, charcoal may be loaded therein, and the insert may be withdrawn before lighting of the charcoal. Inventors have found that the charcoal tends to interlock with itself, maintaining the hollow flue even where the insert has been removed. This is in contrast to a system in which an insert of conical shape may be consumed during lighting of the charcoal, which tends to cause the charcoal to then collapse into such a conical void, as the top pieces may be cantilevered over the lower pieces.

FIG. 2C shows another embodiment of a flue portion for an insert 312 that may be formed of wire, similar to that of FIG. 1B, but which may not include an enlarged base portion, which allows removal of insert prior to lighting of the charcoal, similar to insert 212. Of course, an enlarged base portion or a separate grating separating the upper and lower cavities could be provided. Where a base portion and a flue portion are provided and separable from one another, the flue portion could be removed as described above prior to lighting of the charcoal.

Various features of the disclosed embodiments may be combined with one another. For example, it will be apparent that the flue portion of the insert may be a wire frame, a solid body, or a hollow body. An enlarged base portion may or may not be attached or integrally formed with the flue portion, stabilizing legs may be provided (e.g., at the top, bottom or somewhere between the top and bottom of the flue portion), a funnel may be provided to facilitate easier charcoal loading, a slot or other mechanism may be provided within the insert for facilitating positioning of a piece of charcoal at the bottom of the hollow flue being formed, etc.

FIGS. 3A and 3B illustrate cross-sectional schematic views showing how the charcoal chimney container may be loaded with charcoal around an insert to as to provide a hollow flue that extends the height of internal cavity 110. For example, FIG. 3A shows the container 102 and insert 112 of FIGS. 1A-1C, and in which charcoal briquettes 138 have been loaded into cavity 110 around insert 112. As a result of the presence of insert 112, particularly flue portion 114, an elongate, slender cylindrical hollow flue 140 is provided within cavity 110.

FIG. 3B illustrates an exemplary configuration that may result when an insert (e.g., such as insert 212 FIGS. 2A-2B), is employed, and withdrawn once the charcoal has been loaded within cavity 110, but before lighting of the charcoal 138 has occurred.

FIG. 3B illustrates a single charcoal briquette positioned vertically on end at the bottom of otherwise hollow flue 140, on grating 116, as described above.

It will be appreciated that an insert for use with a charcoal chimney device may be provided separately from the charcoal chimney device (e.g., for use by user's who already have a charcoal chimney device).

### III. Comparative Testing

### Comparative Test 1

Testing was done to test the time to cooking readiness of various insert configurations against one another and as compared to a control (with no hollow flue). Three commercially available Weber charcoal chimneys were tested at the same time. One was used as a control (Example 1A), one included a paper tube insert (e.g., a rolled paper tube) used to make a hollow flue (Example 1B), and the other included a wire insert (Example 1C) similar to that shown in FIG. 2B to make the hollow flue. The paper and wire tubes had a diameter of about 1.25 inch, and extended past the top of the respective chimney. Each charcoal chimney was filled with charcoal briquettes. Examples 1B and 1C were loaded so that the charcoal surrounded the hollow flue insert. Example 1A (the control) was filled to level with the top. Examples 1B and 1C were heaped over the top, to recoup the charcoal volume lost by the insert. The inserts were not removed during testing (i.e., the paper tube of Example 1B was burned up). The tests were conducted simultaneously, under the same environmental conditions, using the same amount of newspaper starter fuel in the bottom. The chimneys were determined to be ready for dumping (i.e., time to cooking readiness) as soon as the center flame was 1-2 inches above the top of the chimney. The results are presented in Table 1, below.

TABLE 1

| | Example 1A | Example 1B | Example 1C |
|---|---|---|---|
| | (Control) | (Paper Tube) | (Wire Tube) |
| Rep 1 (min) | 27.0 | 17.5 | 19.0 |
| Rep 2 (min) | 23.0 | 17.0 | 19.0 |
| Rep 3 (min) | 24.0 | 14.0 | |
| Average time for | 24.7 | 16.2 | 19.0 |
| Cooking Readiness | | | |
| (min) | | | |
| Std. Dev. | 2.1 | 1.9 | |
| Improvement (min) | | 8.5 | 5.7 |
| Percent Improvement | | 34% | 23% |

It was noted that the Rep 2 control was in a somewhat higher wind area during Rep 2, and lit faster as a result.

In Rep 1, of Example 1C, rolled newspaper was placed within the wire tube. In Rep 2 of Example 1C, to test if the improvement was due to improved airflow, the rolled newspaper was removed from the wire tube, so that the hollow flue just had a wire insert (no fuel placed therein). There was no difference relative to Rep 1.

In addition, a check of the coals after they had burned for about 30 minutes was made. The charcoal that was lit using the paper tube (Example 1B) was still as hot as the control (Example 1A). Since it was ready faster, the charcoal of Example 1B was burning more evenly in the chimney, resulting in a longer cook time.

### Comparative Test 2

A similar test as described above in Comparative Test 1 was conducted using a wood dowel (e.g., 1.125 to 1.25 inch diameter) insert, similar to that shown in FIG. 2A, which was in place during loading of the charcoal, but was removed prior to lighting, as compared to a control. Kingsford charcoal chimneys were used. Example 2A (the control) was loaded in a normal manner, while in Example 2B, the charcoal was loaded around the wood dowel insert, which was then removed, leaving a hollow flue in place. The chimney was shaken a little bit to ensure the charcoal was interlocked before the insert was removed. The tests were conducted simultaneously, under the same environmental conditions, using the same amount of newspaper starter fuel in the bottom. The results are presented in Table 2, below.

TABLE 2

| | Example 2A | |
|---|---|---|
| | (Control) | Example 2B |
| Rep 1 (min) | 15 | 11 |
| Improvement (min) | | 4 |
| Percent Improvement | | 27% |

Comparative Test 2 was conducted with a different brand of charcoal, while Comparative Test 1 employed conventional charcoal, accounting for the difference in time to cooking readiness. Comparative Test 2 showed that use of an insert to form a hollow flue within the volume of charcoal improves time to cooking readiness for a variety of different charcoal fuels, and that it is not necessary that the insert remain in the charcoal volume during lighting of the charcoal.

### Comparative Test 3

It had been observed that during some burns, briquettes would fall into the hollow flue and the time to cooking readiness would slow down by 1 to 2 minutes, although once a single briquette fell down into the hollow flue, and landed vertically, on its edge, as illustrated in FIG. 3B. To test the time to cooking readiness of such a configuration, the following test was performed, otherwise similar to that of Comparative Test 2, but where Example 3B included the single vertically oriented briquette at the bottom of the hollow flue. The tests were conducted simultaneously, under the same environmental conditions, using the same amount of newspaper starter fuel in the bottom. It should be noted that the charcoal used in this test lit faster than the previous test in all cases due to the charcoal used (comparing the control products). The benefit of embodiments of the invention disclosed herein has been observed over a range of charcoal with different performance characteristics. The results are presented in Table 3, below.

TABLE 3

| | Example 3A | |
|---|---|---|
| | (Control) | Example 3B |
| Rep 1 (min) | 15 | 9 |
| Improvement (min) | | 6 |
| Percent Improvement | | 40% |

Example 3B, in which the single briquette was positioned at the bottom of the hollow flue (as shown in FIG. 3B), showed the best improvement of the conducted tests.

### Comparative Test 4

Comparative test 4 was similar to that of Comparative Test 3, but with Kingsford blue bag charcoal. Example 4A was the control, and Example 4B included the hollow flue formed with the wood dowel with the single vertically oriented briquette at the bottom of the hollow flue. The tests were conducted simultaneously, under the same environmental conditions, using the same amount of newspaper starter fuel in the bottom. The results are presented in Table 4, below.

TABLE 4

| | Example 4A | |
|---|---|---|
| | (Control) | Example 4B |
| Rep 1 (min) | 18.5 | 11 |
| Rep 2 (min) | | 11.5 |
| Avg. Improvement (min) | | 7.25 |
| Percent Improvement | | 39% |

Example 4B, shows nearly identical improvement over the control as did Example 3B (about 40% faster). The same Kingsford blue bag charcoal was also used with a control that included lighter fluid, which took about 16 minutes to be ready. The use of the hollow flue configuration was actually faster than that achieved using lighter fluid. Thus, the estimated time to readiness may be such that Matchlight charcoal (e.g., charcoal with pre-applied lighter fluid) may be fastest (10-12 minutes, e.g., about 10 minutes), followed by the hollow flue described in Comparative Examples 3 and 4 (9-14 minutes, e.g., about 12 minutes), followed by the use of lighter fluid (15-20 minutes, e.g., about 15 minutes), followed by conventional use of a charcoal chimney (15-24 minutes, e.g., about 20 minutes).

While the present invention has been described with reference to what are presently considered to be the preferred embodiments, it is to be understood that the invention is not limited to these embodiments. To the contrary, the invention is intended to cover various modifications and equivalent arrangements included within the spirit and scope of the appended claims.

1. A reusable charcoal chimney device, comprising:
a charcoal container including a bottom end, an open top end, and a sidewall disposed there between, the charcoal container optionally including an internal cavity for containing charcoal, the charcoal container being formed of a non-combustible material;
an elongate insert disposable within the internal cavity of the charcoal container for forming a hollow flue that extends substantially the entire height of the internal cavity of the charcoal container when the insert is disposed therein and charcoal is loaded into the internal cavity around the insert;
wherein the insert comprises a longitudinally oriented flue portion extending substantially the entire height of the internal cavity; and
wherein a volume occupied by the flue portion of the insert is not more than about 5% of the volume of the internal cavity of the charcoal container.

2. The charcoal chimney device as recited in claim 1, wherein the flue portion of the insert has a substantially uniform transverse cross-section from the bottom of the internal cavity to a top end of the flue portion.

3. The charcoal chimney device as recited in claim 1, wherein the insert further comprises a base portion at a bottom of the flue portion configured to engage with the sidewall of the charcoal container when the insert is disposed within the internal cavity of the charcoal container.

4. The charcoal chimney device as recited in claim 1, wherein the insert comprises a wire or metal frame body.

5. The charcoal chimney device as recited in claim 1, wherein the insert is formed of a material that is non-combustible.

6. The charcoal chimney device as recited in claim 1, wherein the charcoal container includes a second cavity below the internal cavity for containing charcoal, a grating at the bottom of the internal cavity separating the internal cavity from the second cavity disposed there below.

7. The charcoal chimney device as recited in claim 1, wherein the flue portion of the insert includes a slot at a distal end thereof for receiving a charcoal briquette in a vertical orientation so as to facilitate placement of a charcoal briquette in a vertical orientation at the bottom of the hollow flue.

8. The charcoal chimney device as recited in claim 1, further comprising a plurality of laterally extending rods extending from the insert to engage the sidewall of the charcoal container for stabilizing the insert.

9. The charcoal chimney device as recited in claim 8, wherein the laterally extending rods are disposed adjacent the bottom of the internal cavity, the insert further comprising an enlarged grating base at the distal end of the insert which enlarged grating base provides the bottom surface of the internal cavity.

10. The charcoal chimney device as recited in claim 1, wherein a volume occupied by the flue portion of the insert is not more than about 3% of the volume of the internal cavity of the charcoal container.

11. The charcoal chimney device as recited in claim 1, wherein a volume occupied by the flue portion of the insert is not more than about 2% of the volume of the internal cavity of the charcoal container.

12. A reusable charcoal chimney device, comprising:
a charcoal container including a bottom end, an open top end, and a sidewall disposed there between, the charcoal container including an internal cavity for containing charcoal, the charcoal container being formed of a non-combustible material;
an elongate insert disposable within the internal cavity of the charcoal container for forming a hollow flue from a bottom of the internal cavity to the open top end of the charcoal container when charcoal is loaded into the internal cavity around the insert;
wherein the insert is configured to provide the hollow flue with a substantially uniform transverse cross-section from the bottom of the internal cavity to the open top end of the charcoal container.

13. The charcoal chimney device as recited in claim 12, wherein the insert comprises a wire frame body.

14. The charcoal chimney device as recited in claim 12, wherein the insert comprises a solid body.

15. The charcoal chimney device as recited in claim 12, wherein the insert comprises a hollow body.

16. The charcoal chimney device as recited in claim 12, wherein a volume occupied by the hollow flue defined by the insert is not more than about 5% of the volume of the internal cavity of the charcoal container.

17. The charcoal chimney device as recited in claim 12, wherein a volume occupied by the hollow flue defined by the insert is not more than about 2% of the volume of the internal cavity of the charcoal container.

18. An insert for use in forming a hollow flue within an internal cavity of a reusable charcoal chimney device as the internal cavity of the charcoal chimney device is filled with charcoal, the insert comprising:
an elongate insert body disposable within the internal cavity of the charcoal container for forming a hollow flue from a bottom of the internal cavity to the open top end of the charcoal container when charcoal is loaded into the internal cavity around the insert;
wherein the insert comprises a longitudinally oriented elongate flue portion extending substantially the entire height of the internal cavity; and
wherein a volume occupied by the flue portion of the insert is not more than about 10% of the volume of the internal cavity of the charcoal container.

19. The charcoal chimney device as recited in claim 1, further comprising a handle attached to an exterior of the sidewall of the charcoal container.

20. The charcoal chimney device as recited in claim 14, wherein a volume occupied by the hollow flue defined by the insert is not more than about 3% of the volume of the internal cavity of the charcoal container.
